(19) United States
(12) Patent Application Publication
(10) Pub. No.: US 2005/0236318 A1
(43) Pub. Date: Oct. 27, 2005

(54) Low holdup volume multiwell plate

(75) Inventors: Phillip Clark, Wakefield, MA (US); Marc Richard Emerick, Rye, NH (US); Christopher A. Scott, Westford, MA (US); Steven D. Sheridan, Wakefield, MA (US)

Correspondence Address: MILLIPORE CORPORATION, 290 CONCORD ROAD, BILLERICA, MA, 01821, US

(73) Assignee: Millipore Corporation, Billerica, MA (US)

(21) Appl. No.: 11/062,115

(22) Filed: Feb. 18, 2005

Related U.S. Application Data
(60) Provisional application No. 60/565,000, filed on Apr. 23, 2004.

(51) Int. Cl. B01D 25/02

(52) U.S. Cl. 210/323.1; 422/99; 422/104; 422/101; 210/498

(57) ABSTRACT

The present invention provides a device in a multiwell plate that allows for one to obtain substantially all of the liquid that has flowed through the filter thereby reducing hold up volume. This is accomplished by forming at least one hydrophobic area in the hydrophilic filter in each well. After the filtration has occurred, air is allowed to enter the underdrain of the plate through the hydrophobic area(s) which causes any residual fluid held by surface tension to be released and to flow out of the underdrain to the outside environment.

### CROSS REFERENCE RELATED APPLICATIONS

This application claims the benefit of U.S. Provisional Application No. 60/565,000, filed on Apr. 23, 2004.

### BACKGROUND OF THE INVENTION

The use of multiwell plates to filter and purify various products such as proteins, DNA, RNA, plasmids and the like or for use in drug screening or drug discovery in the laboratory is widespread and growing. The advantages are many. The ability to use small volumes of samples required especially with experimental compounds or with the screening of 1000s of potential compounds reduces cost. The ability to run multiple samples at the same time reduces time and cost.

Most plate-based systems are arranged to have a filter plate positioned above, optionally and as shown, a collection plate. Other devices such as other filter plates, waste collectors and the like may also be used. A typical system is shown in FIG. 1. The filter plate 2 has a series of wells 4, typically 96 or 384 or 1536 arranged in orderly rows and columns. The bottom 6 of each well 4 has an opening 8 that is selectively covered by one or more porous filters or membranes 10. The membranes are hydrophilic to allow for the passage of fluids through them at a relatively low amount of force. The collection plate 12 typically has the same number of wells 14 as the filter plate and they are aligned with those of the filter plate so that they collect the fluid from the respective well above it. The bottom 16 of the wells 14 of the collection plate 12 is generally closed as shown although they may be open when collection of the filtrate in individual wells is not important.

All fluid in the filter plate must pass through the filter or membrane 10 before reaching the collection plate well 14. Most filter plates 2 also contain an underdrain 18 below the filter or membrane 10. The underdrain 18 contains a spout 20 to direct the fluid from the filter plate 2 to the well 14 of the collection plate 12 below it. It also contains some type of sloped surface 21 to cause the fluid in the underdrain 18 to move toward the spout 20.

In practice, the system is assembled and placed on a vacuum manifold. The vacuum draws the fluid through the filter plate and underdrain and into the collection plate. However, some fluid remains behind after the filtration has been completed. Typically, this fluid is found in the underdrain and often also as a pendant drop extending downward from the spout.

Several problems exist with leaving some sample behind.

For smaller volume application such as 384 and 1536 well systems (these systems include that number of wells on a plate that is equal in size to that used for a 96 well plate, meaning that the well size and sample size respectively 4× and 16× smaller than that of a 96 well plate system) the loss of sample can amount to 10 to 20% of the entire sample.

For all multiwell systems, the residual fluid can often migrate to adjacent wells along adjacent surfaces or the pendant drops can be transferred to an adjacent well when the plates are taken apart to obtain the material in the collection plate. This leads to cross contamination of the sample and reduces the reliability of the system and the test that has been run. Likewise, many systems run sequential steps in the same system. The residual material can either then be present in the second step sample which is undesirable or it can over time migrate back or wick back through the filter or membrane and be present in the well of the filter plate from which it was removed. If, for example, the first step was a desalting step to remove salts or primers or other chemicals from a sample, this leads to a less pure sample and may complicate the second or later steps performed upon it. Additionally, when the filter plate is picked up and/or moved, any pendant drops tend to rain down on the collection plate, equipment and adjacent laboratory surfaces and thereby contaminating them.

What is desired is a device that provides the advantages of the current multiwell plate system but which reduces or eliminates the issue of liquid holdup. The present invention provides such a system.

### SUMMARY OF THE INVENTION

The present invention relates to a multiwell plate having low holdup volume. More particularly, it relates to a multiwell plate having one or more hydrophobic areas in its membrane(s) to allow substantially all the fluid downstream of the membrane(s) to drain into the collection device.

The present invention provides a device in a multiwell plate that allows for one to obtain substantially all of the liquid that has flowed through the filter thereby reducing hold up volume. This is accomplished by forming at least one hydrophobic area in the filter in each well. After the filtration has occurred, air is allowed to enter the underdrain of the plate through the hydrophobic area(s) which causes any residual fluid held by surface tension and other such forces to be released and to flow into the collection device below the well.

It is an object of the present invention to provide a multiple well filter plate comprising a plate having a top, a bottom and a thickness between the top and the bottom, a plurality of wells extending through the thickness, each well having an open top and at least a partially open bottom, a filter attached adjacent the bottom to form a permeably selective opening to the bottom, the filter having one or more hydrophobic areas, an underdrain having a top surface and a bottom surface, the top surface of the underdrain attached to the bottom of the plate, the underdrain having a series of chambers that register and mate with the bottom of the plurality of well of the plate, so as to ensure that fluid passing the filter of a selected well enters only the respective chamber of the underdrain and each chamber having an opening through the bottom surface of the underdrain to an outside environment.

It is a further object of the present invention to provide a multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface and a bottom surface the top surface of the underdrain attached to the bottom of the plate, the underdrain having a series of chambers that register and mate with the bottom of the plurality of well of the plate, so as to ensure that fluid passing the filter of a selected well enters only the respective chamber of the underdrain, each chamber having an opening through the bottom surface of the underdrain to an outside environment and one or more hydrophobic areas in the filter and a collection device located below the filter plate, the collection plate having a top, a bottom and a thickness between the top and the bottom, one or more wells extending through the thickness, wherein the one or more wells of the collection device are in alignment with the plurality of wells of the filter plate and its associated underdrain chamber and opening.

It is another object of the present invention to provide a device for separating a liquid sample comprising an upper plate having at least two wells integrally connected together, each well having an upper opening and a lower opening, the lower opening being smaller than the upper opening and in the form of a spout, the lower opening being positioned on a bottom surface of the upper plate and a separation layer between the upper opening and the lower opening of the upper plate, a lower collection device arranged below the upper plate, the collection device having one or more wells arranged in register with the two or more wells of the upper plate to receive liquid from the spouts of the upper plate, and wherein the separation layer contains a hydrophobic area of from about 0.5% to about 50% of the upper surface area of the separation layer and which extends substantially through the thickness of the layer.

It is an additional object of the present invention to provide a multiple well filter plate comprising a plate having a top, a bottom and a thickness between the top and the bottom, a plurality of wells extending through the thickness, each well having an open top and at least a partially open bottom, a filter sealed adjacent the bottom to form a permeably selective opening to the bottom, an underdrain having a top surface and a bottom surface the top surface of the underdrain attached to the bottom of the plate, the underdrain having a series of chambers that register and mate with the bottom of the plurality of well of the plate, so as to ensure that fluid passing the filter of a selected well enters only the respective chamber of the underdrain, each chamber having an opening through the bottom surface of the underdrain to an outside environment and one or more hydrophobic areas in the filter and wherein the filter is microporous and the one or more hydrophobic areas are formed on an outer periphery of the filter in each well.

It is another object to provide a device for separating a liquid sample comprising:
a plate having at least two wells integrally connected together, each well having an upper opening and a lower opening, the lower opening being positioned on a bottom surface of the upper plate and a hydrophilic separation layer between the upper opening and the lower opening of the upper plate;
wherein the hydrophilic separation layer contains one or more hydrophobic areas.

It is another object to have a hydrophobic area that extends through the thickness of the separation layer.

It is a further object of the present invention to provide a one piece filter plate with integral underdrain comprising an upper portion and a lower portion, the upper portion having a plurality of wells extending through a thickness of the upper portion, a hydrophilic filter located adjacent an interface between the upper portion and the lower portion of the plate to form a permeably selective opening to the lower portion from the upper portion, the hydrophilic filter containing one or more hydrophobic areas, the lower portion having a series of chambers that register and mate with the bottom of the plurality of wells of the upper portion so as to ensure that fluid passing through the filter of a selected well enters only the respective chamber of the lower portion, each chamber having an opening through a bottom surface of the lower portion to an outside environment.

It is a further object to have the one or more hydrophobic areas formed on the entire outer periphery of the filter in each well.

It is a further object to have the one or more hydrophobic areas formed on a portion of the outer periphery of the filter in each well and to have the opening off-center of the well.

### BRIEF DESCRIPTION OF THE DRAWINGS

FIG. 1 shows the plate system of the prior art.

FIG. 2 shows a filter plate with underdrain and collection plate in cross-sectional view according to one embodiment of the present invention.

FIG. 3 shows one well of the filter plate with underdrain and collection plate of FIG. 2 in cross-sectional view.

FIG. 4A shows a top down view of one well a filter plate according to one embodiment of the present invention.

FIG. 4B shows a top down view of one well a filter plate according to one embodiment of the present invention.

FIG. 4C shows a top down view of one well a filter plate according to one embodiment of the present invention.

FIG. 4D shows a top down view of one well a filter plate according to one embodiment of the present invention.

FIG. 4E shows a top down view of one well a filter plate according to one embodiment of the present invention.

FIG. 4F shows a top down view of one well a filter plate according to one embodiment of the present invention.

FIG. 4G shows a top down view of one well a filter plate according to one embodiment of the present invention.

FIG. 5 shows one well of a filter plate with underdrain and collection plate in cross-sectional view according to another embodiment of the present invention.

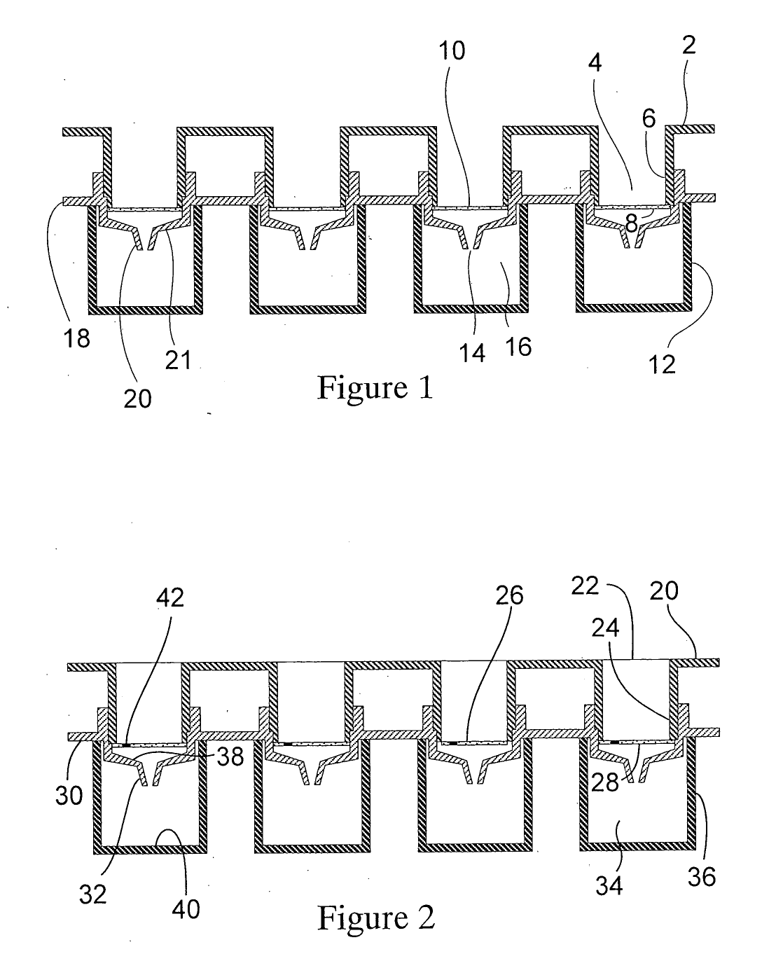

### DETAILED DESCRIPTION OF THE INVENTION

In vacuum applications, the top surface of the liquid column is open to atmosphere, and the underdrain surface is in contact with a negative pressure source creating the pressure differential that drives filtration. Liquid will continue to flow through the hydrophilic membrane by displacing the “held-up” liquid under the membrane in the underdrain's opening and chamber. This process of liquid migrating from the upstream to the downstream side will continue until there is no more upstream liquid to displace the downstream volume. At this point even though the vacuum remains turned on, the wetted membrane is air-locked such that no air can pass through the membrane and displace the downstream held-up liquid volume. The held up liquid can only be removed by exceeding the membrane air intrusion pressure which in most applications is excessively high and not practiced.

However since hydrophobic membranes do not wet with aqueous liquids, they have almost zero air intrusion pressures and readily pass air through to clear out the volume. This invention uses one or more hydrophobic areas that allow air to pass through the membrane after filtration while the vacuum is still on to clear any residual holdup volume. Preferably the area(s) extend through the entire thickness of the membrane, filter or other separations layer so that air can readily pass through it from the top surface to the area below the bottom surface of the membrane, filter or other separations layer. Alternatively it may extend through a substantial portion of the thickness or substantially all of the thickness so that the vacuum energy applied is sufficient to overcome the air intrusion pressures and allow the air to flow rapidly through the layer.

The present invention allows one to reduce or eliminate hold up volume in an underdrain of a multiwell plate through the use of at least one hydrophobic area in the filter of each well. After the filtration has occurred, air is drawn by the vacuum into the underdrain of the plate through the hydrophobic area(s) which causes any residual fluid held in the underdrain to be released and to flow into the collection device below the well. Provided that the vacuum is maintained, all fluid will be displaced into the collection device downstream. If the vacuum is shut off before the draining is complete some residual fluid will remain in the underdrain.

A typical system according to the present invention is shown in FIG. 2. The filter plate 20 has a series of wells 22, typically 96 or 384 or 1536 arranged in orderly rows and columns. The bottom 24 of each well 22 has an opening 26 that is selectively sealed by one or more filters 28.

An underdrain 30 is preferably attached to the bottom 24 of the filter plate 20 below and around the filter 28. The underdrain 30 preferably contains a spout 32 to direct the fluid from the filter plate 20 to a well 34 of a collection plate 36 located below it. It may also contain some type of sloped surface 38 (as shown) to cause the fluid in the underdrain 30 to move toward the spout 32. In other embodiments, (not shown) the sloped surface 38 is not used as this feature is optional and is not required for the device to work.

The collection plate 36 typically has the same number of wells 34 as the filter plate 20 and they 34 are aligned with those 22 of the filter plate 20 so that they 34 collect the fluid from the respective well 22 above it. The bottoms 40 of the collection plate wells 34 are generally closed as shown. Alternatively a single well collection plate may be used where the filtrate is not of interest and the desire is mainly to remove as much filtrate from the system as possible. In another embodiment, the collection device may contain or be a series of ribs or grids in the bottom of a pressure differential manifold (such as a vacuum manifold) that help collect and transfer the filtrate to a common collection place or to waste. While most embodiments will be discussed in relation to a collection plate, it is meant to cover and include other collection devices as well.

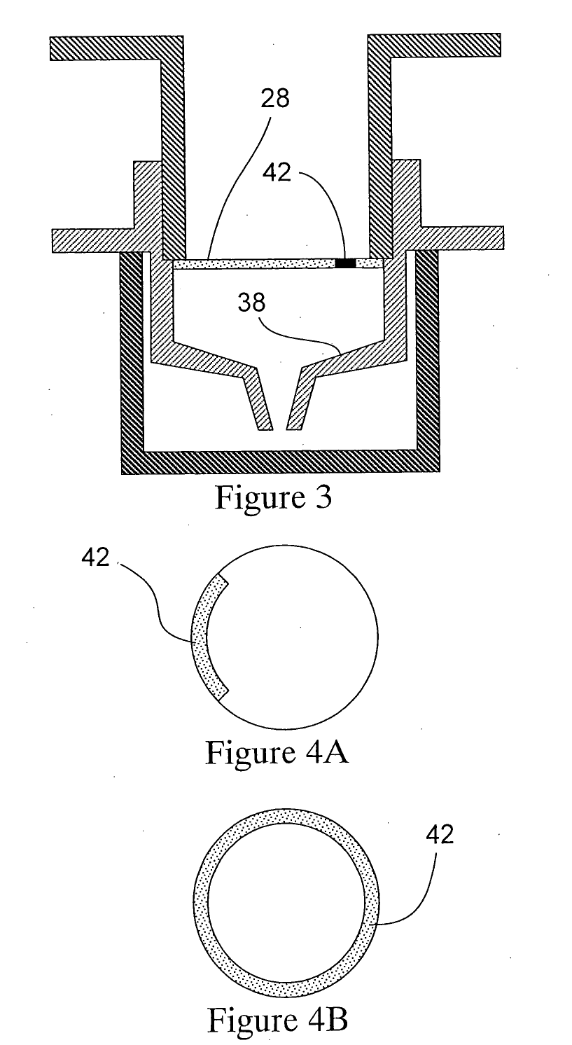

One or more hydrophobic areas 42 are formed in the filter 28 of each well 22 of the filter plate 20. In this example, one area 42 is formed in each well 22. FIG. 3 shows a close view of one well 22 of the filter plate. The hydrophobic area 42 can be clearly seen.

All fluid in the filter plate must pass through the filter 28 before reaching the underdrain 30.

In practice, the system is assembled and placed on a vacuum manifold. The vacuum draws the fluid through the filter 28 and underdrain 30 and into the collection plate 36. However, some fluid remains behind after the filtration has been completed. Typically, this fluid is found in the underdrain 30 and often also as a pendant drop extending downward from the spout 32.

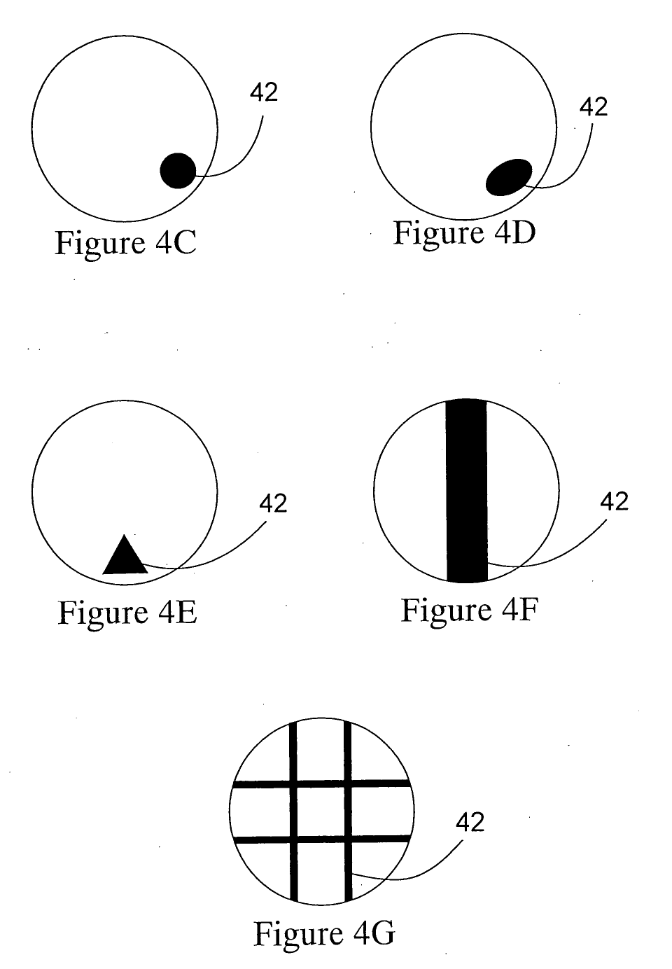

The one or more hydrophobic areas 42 are preferably formed in one area of the filter. In one embodiment, this maybe a portion of the outer periphery of the filter (were it is adjacent the inner wall of the well) as in FIG. 4A. In another embodiment it may be in the form of a ring around the entire outer periphery of the filter adjacent the inner wall of the well as in FIG. 4B. In a further embodiment it is in the form of a spot such as a circle as in FIG. 4C, oval as in FIG. 4D or polygon as in FIG. 4E (triangle, rectangle, square, pentagon and the like). Alternatively, one can use a gridded or striped membrane having hydrophilic areas separated by hydrophobic stripes 42F or grids 42G as shown in FIGS. 4F and 4G. Such membranes are commercially available, such as Gemini™ or Microstar™ membranes, available from Millipore Corporation of Billerica, Mass. The stripe, stripes or grids may be offset or centered as desired or as occurs by random alignment of the striped or gridded membrane to the plate. If desired, a membrane with a specific alignment of the stripe(s) or grids can be made to allow for specific placement of the hydrophobic areas similar to that discussed above in relation to the spots, etc.

The area may be centrally located, however it is preferred that it be positioned at a location away from the spout, preferably along an edge of the filter. By being positioned away from the spout, the area allows for more air to enter the device and to remove more fluid than if the area is positioned above or near the spout of the underdrain. This embodiment is shown in FIG. 3. By being preferably positioned along the edge, it also minimizes the disruption of flow through the filter.

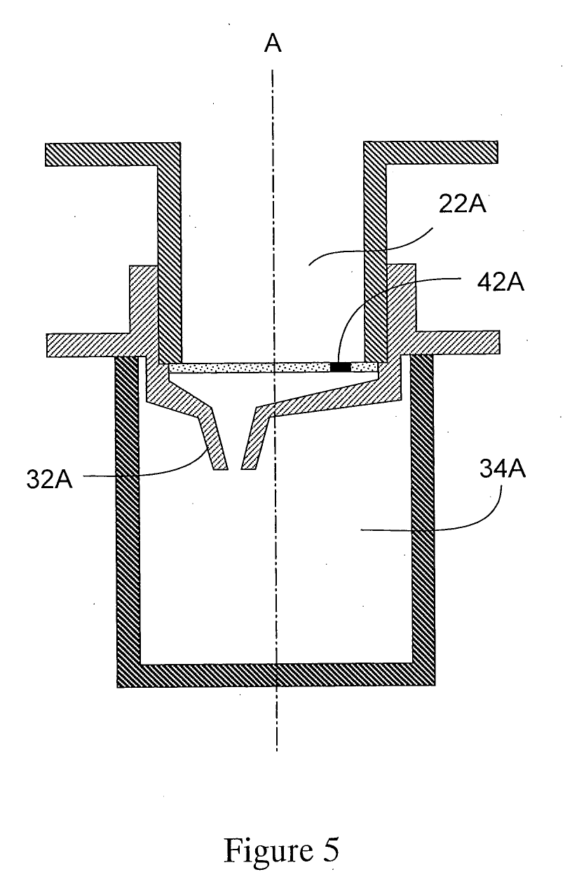

In an embodiment in which the spout 32A is located off center of the filter well 22A and collection plate well 34A as in FIG. 5, it is preferred that the hydrophobic area(s) 42A also be positioned away from the spout 32A, preferably on the portion of the filter that is on the other half of the centerpoint (dotted line A) away from the spout 32A. The spout in this embodiment may be deemed off center of the centerpoint by first determining the centerpoint through the intersection of two or more, preferably three or more diameters of the well and then determining whether the spout is in vertical alignment with the centerpoint or not. If not, then the spout is considered to be offcenter.

The underdrain can be an integral component of the filter plate, having been molded as part of the plate, overmolded on to a preformed plate or preformed separately and bonded to a preformed plate. Alternatively, it can be releasably attached to the bottom of a preexisting plate. In another embodiment, no underdrain is used at all.

Likewise, if a collection device is used it may be in the form of a second filter plate, a collection plate having closed bottoms, a collection plate with one common well or multiple wells and no closed bottom so the filtrate can be collected commonly and/or drained to waste. The collection device can also be a grid or other structure designed simply help draw the filtrate from the filter plate to a downstream place.

Suitable polymers which can be used to form the underdrain and the filter plate include but are not limited to polycarbonates, polyesters, nylons, PTFE resins and other fluoropolymers, acrylic and methacrylic resins and copolymers, polysulphones, polyethersulphones, polyarylsulphones, polystyrenes, polyvinyl chlorides, chlorinated polyvinyl chlorides, ABS and its alloys and blends, polyolefins, preferably polyethylenes such as linear low density polyethylene, low density polyethylene, high density polyethylene, and ultrahigh molecular weight polyethylene and copolymers thereof, polypropylene and copolymers thereof and metallocene generated polyolefins.

Preferred polymers are polyolefins, in particular polyethylenes and their copolymers, polystyrenes and polycarbonates.

The underdrain and filter plate may be made of the same polymer or different polymers as desired.

Likewise the polymers may be clear or rendered optically opaque or light impermeable. When using opaque or light impermeable polymers, it is preferred that their use be limited to the side walls so that one may use optical scanners or readers on the bottom portion to read various characteristics of the retentate. When the filter is heat bonded to the underdrain, it is preferred to use polyolefins due to their relatively low melting point and ability to form a good seal between the device and the filter.

The filter may be of any variety commonly used in filtering biological specimens including but not limited to microporous membranes, ultrafiltration membranes, nanofiltration membranes, or reverse osmosis membranes. Preferably microporous membranes, ultrafiltration membranes or nanofiltration membranes are used. Even more preferably, microporous and ultrafiltration membranes are used.

Representative suitable microporous membranes include nitrocellulose, cellulose acetate, polysulphones including polyethersulphone and polyarylsulphones, polyvinylidene fluoride, polyolefins such as ultrahigh molecular weight polyethylene, low density polyethylene and polypropylene, nylon and other polyamides, PTFE, thermoplastic fluorinated polymers such as poly (TFE-co-PFAVE), polycarbonates or particle filled membranes such as EMPORE® membranes available from 3M of Minneapolis, Minn. Such membranes are well known in the art and are commercially available from a variety of sources including Millipore Corporation of Billerica, Mass. If desired these membranes may have been treated to render them hydrophilic. Such techniques are well known and include but are not limited to grafting, crosslinking or simply polymerizing hydrophilic materials or coatings to the surfaces of the membranes.

Representative ultrafiltration or nanofiltration membranes include polysulphones, including polyethersulphone and polyarylsulphones, polyvinylidene fluoride, and cellulose. These membranes typically include a support layer that is generally formed of a highly porous structure. Typical materials for these support layers include various non-woven materials such as spun bounded polyethylene or polypropylene, or glass or microporous materials formed of the same or different polymer as the membrane itself. Such membranes are well known in the art, and are commercially available from a variety of sources such as Millipore Corporation of Billerica, Mass.

As described above, when using a plate in which it is important to retain the filtrate from each well separately the wells of the first plate should register with the wells of the second plate. Typically multiple well plates have been made in formats containing 6, 96, 384 or up to 1536 wells and above. The number of wells used is not critical to the invention. This invention may be used with any multiple number of wells provided that the filter is capable of being secured to the filter plate in a manner which forms a liquid tight seal between the periphery of the filter and the end of the wells of the plate. The wells are typically arranged in mutually perpendicular rows. For example, a 96 well plate will have 8 rows of 12 wells. Each of the 8 rows is parallel and spaced apart from each other. Likewise, each of the 12 wells in a row is spaced apart from each other and is in parallel with the wells in the adjacent rows. A plate containing 1536 wells typically has 128 rows of 192 wells.

A variety of methods for forming a device according to the present invention may be used. Any method which seals the membrane within the well of the plate (in the single plate design) and on or in the well of the bottom plate (in the two plate design) such that all fluid within the well must pass through the filter before leaving the well through the bottom opening will be useful in this invention.

One method of forming such a device is to form a single plate of a suitable plastic as described above and use a mechanical seal between the well wall and the filter. In this embodiment, there is an undercut formed around the periphery of the inner wall of the well. The filter is sized so as to fit within the undercut portion of the well. The filter is placed within the well. Optionally, a sealing gasket is applied on top of the filter within the undercut. This sealing gasket applies pressure to the filter and ensures that all the fluid must pass through the filter thereby eliminating any leakage or bypass of the filter by the fluid. This gasket may be in the form of a preformed gasket such as an O-ring. Alternatively, a gasket formed of a molten or liquid material may be cast into the undercut to seal the filter in place. An example of a molten material suitable for this embodiment, are any of the well-known hot melt materials such as polyethylene or polypropylene or ethylene vinyl acetate copolymers. A liquid gasket may be formed of any curable rubber or polymer such as an epoxy, urethane or synthetic rubber.

Another method of forming such a device is to use an adhesive to bond and seal the edge of the filter within the well such as all fluid must pass through the filter before entering the opening in the bottom of the well. Adhesive may be either molten or curable as discussed above.

A further method is to use a thermal bond to secure the filter to the well. In this embodiment, a filter sealing device which has a sealing surface which is heated is brought into contact with the upper filter surface and transfer its thermal energy to the surrounding filter and well material. The energy causes either the filter material or the well materials or both to soften and or melt and fuse together forming an integral, fluid tight seal. This process may be used when either the filter material or the well material or both are formed of a thermoplastic material. It is preferred that the well as well as at least a portion of the filter material adjacent the downstream side of the filter be formed of a thermoplastic material. The sealing surface is only a portion of the filter surface and is a continuous structure so that a ring or peripheral area of the filter is sealed to the well so as to form a liquid tight seal between the filter, the well and the opening in the bottom of the well.

The one or more hydrophobic areas can be created in a variety of ways.

One can purchase a preformed hydrophilic membrane that has a grid pattern of hydrophobic areas dividing and isolating the hydrophilic areas from each other. Such membranes are commercially available as Gemini™ or Microstar™ membranes available from Millipore Corporation of Billerica, Mass. The membrane can be simply bonded across the bottom of the plate as a single sheet, bonded across the bottom of the plate as a single sheet with the area beyond each well then removed or cut into individual pieces for each well and either bonded to the bottom of each well or retained in each well by friction, heat sealing, adhesives, undercuts, rings and the like. The only issue is to be sure that at least one area of hydrophobic area of the membrane is within the active filtration area of each well.

Alternatively one can use the process of U.S. Pat. No. 4,618,533 or U.S. Pat. No. 5,629,084 or U.S. Pat. No. 5,814,372 to render a portion of a hydrophilic membrane hydrophobic by using a mask or the like to shield off the area(s) that are not to be rendered hydrophilic or hydrophobic as desired.

This method is to take a membrane or filter and apply one or more monomers or polymers of the desired characteristic, optionally, crosslinkers, and free radical agents and coat them onto at least a portion of the surface of the filter. The filter is then subjected to a polymerizing energy such as heat, UV light or radiation such as gamma to cause the polymerization of the coating in place.

In a modified version of the process, one can start with an inherently hydrophobic membrane such as PVDF and use one of the processes above to render most of the filter area in each well hydrophilic. As with the method above, the areas to remain hydrophobic are masked off before treatment.

In either case, the treatment can occur to a large sheet that is then applied either as a single sheet or individual filter elements to the plate.

In another embodiment the filters are treated after they have been applied to the plate.

Other methods of forming hydrophobic areas such as grafting of materials (U.S. Pat. No. 3,253,057) or the temporary application of hydrophobic materials such as various fluorinated surfactants (Scotchgard® brand surfactants) into the selected areas of the filter may also be used.

The amount of area in each well that comprises the hydrophobic area(s) can vary widely depending upon the pore size of the filter used, the amount of fluid normally retained in the underdrain by an untreated system, the speed at which the liquid movement is desired to occur, the size of the area of each well, and other such factors. Typically, the hydrophobic area(s) in total amount to from about 0.5 to about 50% of the active filter area in each well. As discussed above the area(s) preferably extend through the entire thickness of the filter layer to allow for easy air movement. However, in some applications the area(s) need only extend substantially through or essentially through the thickness so that the vacuum force is sufficient to overcome any resistance to the air moving through the filter thickness.

1) A multiple well filter plate comprising a plate having a top, a bottom and a thickness between the top and the bottom, a plurality of wells extending through the thickness, each well having an open top and at least a partially open bottom, a hydrophilic filter located adjacent the bottom of each well to form a permeably selective opening to the bottom, the hydrophilic filter containing one or more hydrophobic areas, an underdrain having a top surface and a bottom surface the top surface of the underdrain attached to the bottom of the plate, the underdrain having a series of chambers that register and mate with the bottom of the plurality of wells of the plate, so as to ensure that fluid passing the filter of a selected well enters only the respective chamber of the underdrain, each chamber having an opening through the bottom surface of the underdrain to an outside environment.

2) The plate of claim 1 wherein the filter is a microporous filter and the hydrophobic area is formed on a portion of an outer periphery of the filter in each well.

3) The plate of claim 1 wherein the filter is a microporous filter and the hydrophobic area is formed on an entire periphery of the filter in each well.

4) The plate of claim 1 further comprising the chamber has one or more sloped surfaces extending from its periphery to the opening and wherein the hydrophobic area is formed on a portion of the outer periphery of the filter furthest from the opening.

5) The plate of claim 1 wherein the filter is a microporous filter and the hydrophobic area is formed on a portion of an outer periphery of the filter in each well and is in a form selected from the group consisting of a spot, a stripe and a ring.

6) The plate of claim 1 wherein the filter is a microporous filter and the hydrophobic area is formed on a portion of an outer periphery of the filter in each well in the form of a spot wherein the spot is in a form selected from the group consisting of a circle, an oval, a triangle and a polygon.

7) The plate of claim 1 further comprising the chamber has one or more sloped surfaces extending from its periphery to the opening, the hydrophobic area is formed on a portion of the outer periphery of the filter furthest from the opening in the form of a spot.

8) The plate of claim 1 further comprising the chamber has one or more sloped surfaces extending from its periphery to the opening and the opening is located offcenter of a centerpoint of the well.

9) The plate of claim 1 further comprising the chamber has one or more sloped surfaces extending from its periphery to the opening, the opening is located offcenter of a centerpoint of the well and the hydrophobic area is formed on a portion of the outer periphery of the filter furthest from the opening.

10) The plate of claim 1 further comprising the chamber has one or more sloped surfaces extending from its periphery to the opening, the opening is located offcenter of a centerpoint of the well, the hydrophobic area is formed on a portion of the outer periphery of the filter furthest from the opening in the form of a spot.

11) A multiple well plate filtration system comprising a filter plate having a top, a bottom and a thickness between the top and the bottom, a plurality of wells extending through the thickness, each well having an open top and at least a partially open bottom, a hydrophilic filter located adjacent the bottom to form a permeably selective opening to the bottom, the filter having one or more hydrophobic areas, an underdrain having a top surface and a bottom surface the top surface of the underdrain attached to the bottom of the plate, the underdrain having a series of chambers that register and mate with the bottom of the plurality of well of the plate, so as to ensure that fluid passing the filter of a selected well enters only the respective chamber of the underdrain, each chamber having an opening through the bottom surface of the underdrain to an outside environment and a collection device located below the filter plate.

12) A device for separating a liquid sample comprising:
an upper plate having at least two wells integrally connected together, each well having an upper opening and a lower opening, the lower opening being smaller than the upper opening and in the form of a spout, the lower opening being positioned on a bottom surface of the upper plate and a hydrophilic separation layer between the upper opening and the lower opening of the upper plate:
a lower collection plate arranged below the upper plate, the collection plate having one or more wells arranged in register with the two or more wells of the upper plate to receive liquid from the spouts of the upper plate; and
wherein the hydrophilic separation layer contains a hydrophobic area of from about 0.5% to about 50% of the upper surface area of the separation layer.

13) The plate of claim 1 wherein the filter is a microporous filter and the hydrophobic area is formed as one or more stripes.

14) The plate of claim 1 wherein the filter is a microporous filter and the hydrophobic area is formed as one or more spots.

15) The plate of claim 1 wherein the filter is a microporous filter and the hydrophobic area is formed as one or more rings.

16) A device for separating a liquid sample comprising:
a plate having at least two wells integrally connected together, each well having an upper opening and a lower opening, the lower opening being positioned on a bottom surface of the upper plate and a hydrophilic separation layer between the upper opening and the lower opening of the upper plate; and
wherein the hydrophilic separation layer contains one or more hydrophobic areas.

17) The device of claim 16 wherein the one or more hydrophobic areas are present in an amount from about 0.5 to about 50% of the surface of the filter in each well.

18) The device of claim 16 wherein the one or more hydrophobic areas are in a form selected from the group consisting of a spot, a stripe and a ring.

19) The device of claim 16 wherein the one or more hydrophobic areas are in a form selected from the group consisting of a spot, a stripe and a ring and the one or more hydrophobic areas are present in an amount from about 0.5 to about 50% of the surface of the filter in each well.

20) The device of claim 16 wherein the one or more hydrophobic areas are in a form of a spot.

21) The device of claim 16 wherein the one or more hydrophobic areas are in a form of one or more stripes.

22) The device of claim 16 wherein the one or more hydrophobic areas are in a form of a ring.

23) The device of claim 16 wherein the one or more hydrophobic areas are in a form of a stripe formed across a center of the filter in each well.

24) The device of claim 16 wherein the one or more hydrophobic areas are in a form of a stripe formed across one or more edges of the filter in each well.

25) The device of claim 16 wherein the one or more hydrophobic areas are two or more and in a form of stripes that intersect each other.

26) The device of claim 16 wherein the one or more hydrophobic areas are two or more and in a form of stripes that intersect each other to form a series of grids.

27) The plate of claim 1 wherein the filter is a microporous filter and the hydrophobic area is formed as one or more stripes that intersect each other.

28) The plate of claim 1 wherein the filter is a microporous filter and the hydrophobic area is formed as one or more stripes that intersect each other to form a series of grids.

29) The plate of claim 1 wherein the plate and underdrain are formed as one integral piece.

30) The plate of claim 1 wherein the one or more hydrophobic areas extend through a thickness of the filter.

31) The plate of claim 1 wherein the one or more hydrophobic areas extend substantially through a thickness of the filter.

32) The plate of claim 1 wherein the one or more hydrophobic areas extend essentially through a thickness of the filter.

33) A multiple well filter plate comprising an upper portion and a lower portion, the upper portion having a plurality of wells extending through a thickness of the upper portion, a hydrophilic filter located adjacent an interface between the upper portion and the lower portion of the plate to form a permeably selective opening to the lower portion from the upper portion, the hydrophilic filter containing one or more hydrophobic areas, the lower portion having a series of chambers that register and mate with the bottom of the plurality of wells of the upper portion so as to ensure that fluid passing through the filter of a selected well enters only the respective chamber of the lower portion, each chamber having an opening through a bottom surface of the lower portion to an outside environment.
